(19) United States
(12) Patent Application Publication
(10) Pub. No.: US 2025/0016638 A1
(43) Pub. Date: Jan. 9, 2025

(54) RADIO LINK FAILURE TRIGGER AND RECOVERY IN CASE OF SIDELINK CARRIER AGGREGATION

(71) Applicant: Telefonaktiebolaget LM Ericsson (publ), Stockholm (SE)

(72) Inventors: Min WANG, Luleå (SE); Antonino ORSINO, Kirkkonummi (FI)

(21) Appl. No.: 18/705,233

(22) PCT Filed: Oct. 28, 2022
(86) PCT No.: PCT/EP2022/080285

§ 371 Date: Apr. 26, 2024

Related U.S. Application Data
(60) Provisional application No. 63/273,455, filed on Oct. 29, 2021.

(51) Int. Cl. H04W 36/00; H04W 72/25; H04W 76/19; H04W 76/27; H04W 76/28

(52) U.S. Cl. CPC H04W 36/0079; H04W 72/25; H04W 76/19; H04W 76/27; H04W 76/28

(57) ABSTRACT

A method in a sidelink, SL, user equipment, UE, configured with SL carrier aggregation, CA, to handle SL radio link failure, RLF, per SL carrier includes monitoring at least one of radio channel quality, radio link control, RLC, transmission, or hybrid automatic repeat request, HARQ, discontinuous transmission, DTX, per SL carrier. The method includes for each SL carrier, responsive to determining there is a SL RLF in the SL carrier: reporting SL RLF to at least one peer SL UE using at least one SL carrier of SL carriers that are not failed in a SL carrier configuration associated with the SL carrier having the SL RLF; and when the SL UE is connected to a base station, gNB, reporting the SL RLF to the gNB.

### TECHNICAL FIELD

The present disclosure relates generally to communications, and more particularly to communication methods and related devices and nodes supporting wireless communications.

### BACKGROUND

### New Radio (NR) Sidelink (SL)

NR SL communication was specified by the 3rd generation partnership project (3GPP) in Rel-16. The NR SL is an evolution of the long term evolution (LTE) sidelink, in particular of the features introduced in Rel-14 and Rel-15 for vehicle-to-anything (V2X) communication. Some of the features of the NR sidelink include:
Support for unicast and groupcast transmissions, in addition to broadcast transmissions, which were already supported in LTE.
Support for hybrid automatic repeat request (HARQ) feedback over the SL for unicast and groupcast. This feedback is conveyed by the receiver user equipment (UE) to the transmitted UE using the physical sidelink feedback channel (PSFCH). This functionality is new in NR compared to LTE.
To alleviate resource collisions among different sidelink transmissions launched by different UEs, it enhances channel sensing and resource selection procedures, which also lead to a new design of physical channels carrying the sidelink control information (SCI). The new design of the SCI simplifies coexistence between releases by grouping together all the information related to resource allocation (which is required for coexistence) in a single channel with a robust, predefined format. Other control information is carried by other means, in a more flexible manner.
Grant-free transmissions, which are supported in NR uplink transmissions, are also provided in NR sidelink transmissions, to improve the latency performance.
To achieve a high connection density, congestion control and thus the quality of service (QOS) management is supported in NR sidelink transmissions.

### NR SL Physical Channels

In NR SL, physical layer (PHY) channels have been defined. These PHY channels are:
PSCCH (Physical Sidelink Common Control Channel): This channel carries sidelink control information (SCI) including part of the scheduling assignment (SA) that allows a receiver (RX) to further process and decode the corresponding PSSCH (e.g., demodulation reference signal (DMRS) pattern and antenna port, modulation and coding scheme (MCS), etc.). In addition, the PSCCH indicates future reserved resources. This allows a RX to sense and predict the utilization of the channel in the future. This sensing information is used for the purpose of UE-autonomous resource allocation (Mode 2), which is described below.
PSSCH (Physical Sidelink Shared Channel): The PSSCH is transmitted by a sidelink transmitter UE, which conveys sidelink transmission data (i.e., the SL shared channel SL-SCH), and a part of the sidelink control information (SCI). In addition, higher layer control information may be carried using the PSSCH (e.g., medium access control-control elements (MAC CEs), radio resource control (RRC) signaling, etc.). For example, channel state information (CSI) is carried in the MAC CE over the PSSCH instead of the PSFCH.
PSFCH (Physical Sidelink feedback channel): The PSFCH is transmitted by a sidelink receiver UE for unicast and groupcast. It conveys the SL HARQ acknowledgement, which may consist of acknowledgement/non-acknowledgement (ACK/NACK) (used for unicast and groupcast option 2) or NACK-only (used for groupcast option 1).
Physical Sidelink Broadcast Channel (PSBCH): The PSBCH conveys information related to synchronization, such as the direct frame number (DFN), indication of the slot and symbol level time resources for sidelink transmissions, in-coverage indicator, etc. The synchronization signal block (SSB) is transmitted periodically at every 160 ms. The PSBCH is transmitted along with the sidelink primary synchronization signal/sidelink secondary synchronization signal (S-PSS/S-SSS) as a sidelink synchronization signal block (S-SSB).
   S-PSS/S-SSS are used by UEs to establish a common timing references among UEs in the absence of another reference such as global navigation satellite systems (GNSS) time of network (NW) time.
      Along with the different physical channels, reference signals are transmitted for different purposes, including demodulation (DM) reference signal (RS) (DMRS), phase tracking RS (PT-RS), or RS for channel state information acquisition (CSI-RS).

Another new feature is the two-stage sidelink control information (SCI). A first part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining part (second stage) of the SCI carries the remaining scheduling and control information such as a 8-bits source identity (ID) and a 16-bits destination ID, new data indicator (NDI), redundancy version (RV) and HARQ process ID is sent on the PSSCH to be decoded by the receiver UE.

### Resource Allocation

NR sidelink supports the two modes of resource allocation. The two modes are:
Mode 1: Sidelink resources are scheduled by a g-Node B (gNB).
Mode 2: The UE autonomously selects sidelink resources from a (pre-) configured sidelink resource pool. To avoid collisions between UEs, a procedure based on the channel sensing and resource reservation is used.

An in-coverage UE can be configured by a gNB to use Mode 1 or Mode 2. For the out-of-coverage UE, only Mode 2 can be used.

In Mode 1, the grant is provided by the gNB. There are two kinds of grants that are supported—dynamic grants and configured grants.

Dynamic Grant: Dynamic grants are provided for one or multiple transmissions of a single packet (i.e., transport block). When the traffic to be sent over sidelink arrives at a transmitter UE (i.e., at the corresponding transmission (TX) buffer), the UE initiates a four-message exchange procedure to request sidelink resources from a gNB (scheduling request (SR) on UL, grant, buffer status report (BSR) on uplink (UL), grant for data on SL sent to UE). A gNB indicates the resource allocation for the PSCCH and the PSSCH in the downlink control information (DCI) conveyed by PDCCH with cyclic redundancy check (CRC) scrambled with the SL-RNTI (sidelink-radio network temporary identifier) of the corresponding UE. A UE receiving such a DCI, assumes that it has been provided a SL dynamic grant only if the detects that the CRC of DCI has been scrambled with its SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.

Configured Grant: For traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. This grant is known as a configured grant. Upon traffic arriving at a transmitter UE, this UE can launch the PSCCH and the PSSCH on the upcoming resource occasion. This kind of grant is also known as grant-free transmissions.

Note that only the transmitter UE is scheduled by the gNB. The receiver UE does not receive any information directly from the gNB. Instead, it is scheduled by the transmitter UE by means of the SCI. Therefore, a receiver UE should perform blind decoding to identify the presence of PSCCH and find the resources for the PSSCH through the SCI.

In Mode 2 resource allocation, the grant is generated by the UE itself. When traffic arrives at a transmitter UE (i.e., at the corresponding TX buffer), this transmitter autonomously selects resources for the PSCCH and the PSSCH. To further enhance the probability of successful TB decoding at one shot and thus suppress the probability to perform retransmissions, a transmitter UE may repeat the TB transmission along with the initial TB transmission. These retransmissions may be triggered by the corresponding SL HARQ feedback or may be sent blindly by the transmitter UE. In either case, to minimize the probability of collision for potential retransmissions, the transmitter UE may also reserve the corresponding resources for PSCCH/PSSCH for retransmissions. That is, the transmitter UE selects resources for:
1. The PSCCH/PSSCH corresponding to the first transmission
2. The PSCCH/PSCCH corresponding to the retransmissions. Resources for up to 2 retransmissions may be reserved. These reserved resources are always used in case of blind retransmissions. If SL HARQ feedback is used, the used of the reserved resources is conditional on a negative SL HARQ acknowledgement.

Since each transmitter UE in sidelink transmissions should autonomously select resources for its own transmissions, preventing the different transmitter UEs from selecting the same resources turns out to be an issue in Mode 2. A particular resource selection procedure is therefore imposed to Mode 2 based on channel sensing. The channel sensing algorithm involves detecting the reservations transmitted by other UEs and performing power measurements (i.e., reference signal received power or RSRP) on the incoming transmissions.

### HARQ-Based Sidelink RLF Detection

As described in clause 5.22.1.3.3 of 3GPP Technical Specification (TS) 38.321 V 16.6.0, the HARQ-based Sidelink RLF detection procedure is used to detect Sidelink RLF based on a number of consecutive DTX on PSFCH reception occasions for a PC5-RRC connection (The PC5 interface is the interface between the receiver UE and the transmitter UE).

### SUMMARY

In 3GPP, carrier aggregation (CA) is being proposed for Rel-18 SL topics.

In Uu CA (i.e., carrier aggregation on the Uu interface between the UE and a base station (BS)), RLF may be triggered for the UE considering radio link status of all configured cells. In other words, there is no RLF handling for each cell. This is partly due to that there may be only downlink (DL) carrier in a secondary cell (SCell). Further, the UE performs radio link monitoring (RLM) only on the primary cell (PCell) and this RLM is valid for the PCell and all the SCell(s) configured.

However, for the UE configured with SL CA, the situation is different. For each SL carrier, transmission is bidirectional. There is no concept of UL or DL but only a sidelink carrier where both sidelink UEs can transmit in a scheduled way. The UE may experience bad radio conditions in either or both directions. In addition, the HARQ-based Sidelink RLF detection procedure is used to detect Sidelink RLF based on a number of consecutive DTX on PSFCH reception occasions for a PC5-RRC connection. This is a fundamental difference from Uu connections where the UE that is configured to use CA can understand if there is an RLF or not only based on the max number of RLC retransmissions.

In case of SL carrier aggregation, a UE pair including UE1 and UE2 may be configured with more than two SL carriers. The SL CA is expected to reuse existing functionalities of Uu CA. Therefore, a UE would be configured with separate HARQ entities for different SL carriers. However, the UE maintains a common PC5-RRC connection and a common MAC entity for all SL carriers. If the number of consecutive DTX occasions reaches a maximum number in the common PC5-connection, the UE would then trigger SL RLF for the PC5-connection, which in the case of CA, would be a SL RLF for all carriers. However, the failure may be just due to a single carrier which has bad radio channel quality or has been congested, while the other carriers are still in good condition. In this case, it would not be efficient to let the UE to declare SL RLF.

Certain aspects of the disclosure and their embodiments may provide solutions to these or other challenges. For example, according to some embodiments of inventive concepts, a method in a sidelink, SL, user equipment, UE, configured with SL carrier aggregation, CA, to handle SL radio link failure, RLF, per SL carrier includes monitoring at least one of radio channel quality, radio link control, RLC, transmission, or hybrid automatic repeat request, HARQ, discontinuous transmission, DTX, per SL carrier. The method further includes for each SL carrier, responsive to determining there is a SL RLF in the SL carrier: reporting SL RLF to at least one peer UE using other SL carriers that are not failed and reporting the SL RLF to a base station, gNB, via an interface responsive to the SL UE being connected to the gNB.

Certain embodiments may provide one or more of the following technical advantage(s). The various embodiments of inventive concepts enable a SL carrier to be activated or deactivated among all configured SL carriers that are part of SL carrier aggregation. The UE is thus able to achieve a good balance between power saving and QoS satisfaction of services.

According to other embodiments of inventive concepts, a method in a base station includes receiving signaling from a sidelink, SL, user equipment, UE, configured with SL carrier aggregation, CA indicating detection of SL radio link failure, RLF, for a SL carrier. The method includes sending a signaling to the SL UE informing the SL UE of at least one of: deactivating the SL carrier on which the SL RLF has been detected for the SL UE; de-configuring the SL carrier on which the SL RLF has been detected for the SL UE; adding a SL carrier to replace the SL carrier on which the SL RLF has been detected; informing the SL RLF to a peer SL UE of the SL UE via dedicated radio resource control, RRC, signaling; reconfiguring the SL carrier; tearing down the PC5-RRC connection for the SL UE; reconfiguring or reestablishing the PC5-RRC connection for the SL UE; and de-activating CA for the PC5 connection between the SL UE and the peer SL UE.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating a wireless device UE according to some embodiments of inventive concepts;

FIG. 2 is a block diagram illustrating a radio access network RAN node (e.g., a base station e-Node B/g-NodeB (eNB/gNB)) according to some embodiments of inventive concepts;

FIG. 3 is a signaling diagram illustrating an embodiment of SL RLF handling in case of SL CA according to some embodiments of inventive concepts;

FIGS. 4-5 are flow charts illustrating operations of a SL UE according to some embodiments of inventive concepts;

FIG. 6 is a flow chart illustrating operations of a base station according to some embodiments of inventive concepts;

FIG. 7 is a block diagram of a communication system in accordance with some embodiments;

FIG. 8 is a block diagram of a user equipment in accordance with some embodiments

FIG. 9 is a block diagram of a network node in accordance with some embodiments;

FIG. 10 is a block diagram of a host computer communicating with a user equipment in accordance with some embodiments;

FIG. 11 is a block diagram of a virtualization environment in accordance with some embodiments; and

FIG. 12 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

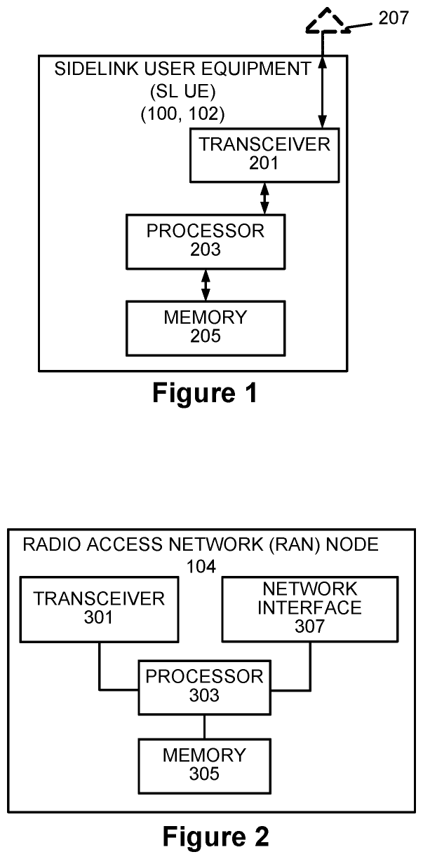

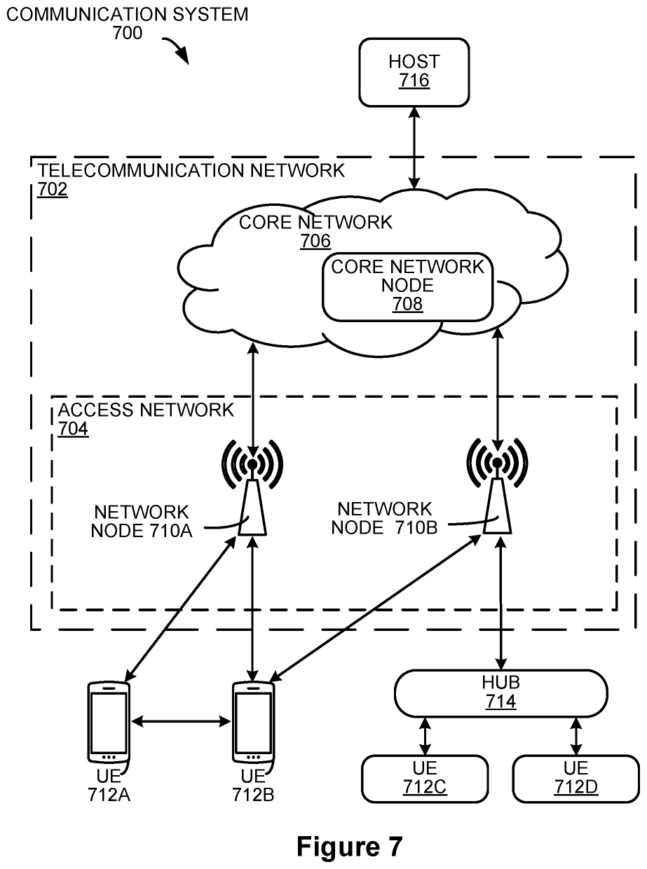

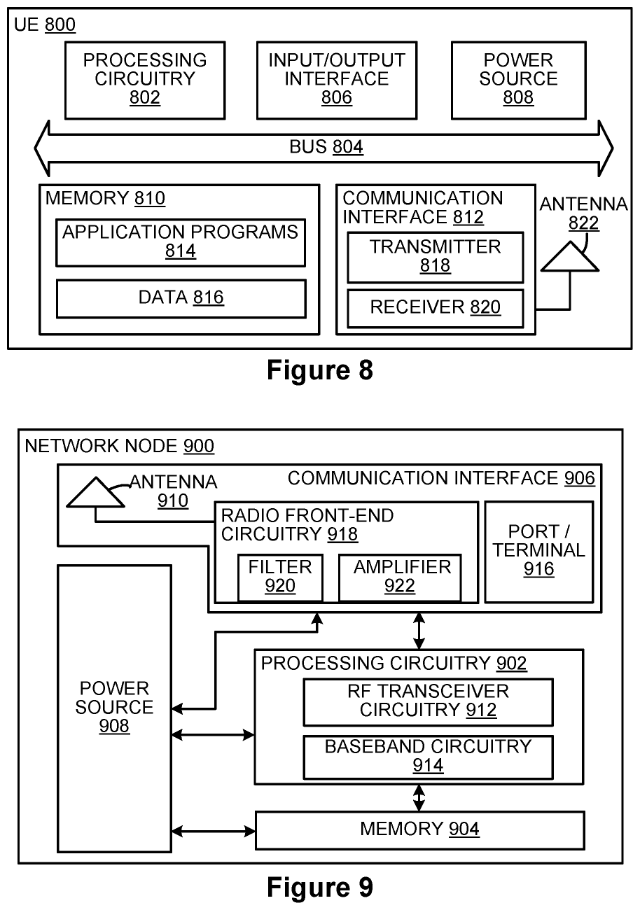

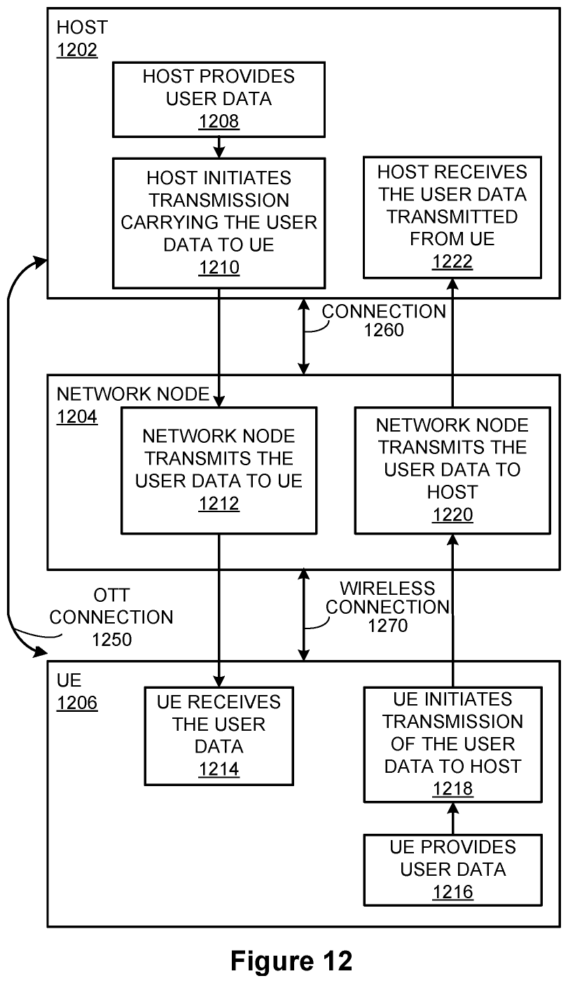

Prior to describing the embodiments, various components in the embodiments shall first be described. FIG. 1 is a block diagram illustrating elements of a sidelink (SL) UE 100, 102 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (SL UE 100, 102 may be provided, for example, as discussed below with respect to wireless devices UE 712A, UE 712B, and wired or wireless devices UE 712C, UE 712D of FIG. 7, UE 800 of FIG. 8, virtualization hardware 1104 and virtual machines 1108A, 1108B of FIG. 11, and UE 1206 of FIG. 12, all of which should be considered interchangeable in the examples and embodiments described herein and be within the intended scope of this disclosure, unless otherwise noted.) As shown, SL UE 100, 102 may include an antenna 207 (e.g., corresponding to antenna 822 of FIG. 8), and transceiver circuitry 201 (also referred to as a transceiver, e.g., corresponding to interface 812 of FIG. 8 having transmitter 818 and receiver 820) including a transmitter and a receiver configured to provide uplink and downlink radio communications with a base station(s) (e.g., corresponding to network node 710A, 710B of FIG. 7, network node 900 of FIG. 9, and network node 1204 of FIG. 12 also referred to as a RAN node) of a radio access network. SL UE 100, 102 may also include processing circuitry 203 (also referred to as a processor, e.g., corresponding to processing circuitry 802 of FIG. 8, and control system 1112 of FIG. 11) coupled to the transceiver circuitry, and memory circuitry 205 (also referred to as memory, e.g., corresponding to memory 810 of FIG. 7) coupled to the processing circuitry. The memory circuitry 205 may include computer readable program code that when executed by the processing circuitry 203 causes the processing circuitry to perform operations according to embodiments disclosed herein. According to other embodiments, processing circuitry 203 may be defined to include memory so that separate memory circuitry is not required. SL UE 100, 102 may also include an interface (such as a user interface) coupled with processing circuitry 203, and/or SL UE 100, 102 may be incorporated in a vehicle.

As discussed herein, operations of SL UE 100, 102 may be performed by processing circuitry 203 and/or transceiver circuitry 201. For example, processing circuitry 603 may control transceiver circuitry 201 to transmit communications through transceiver circuitry 601 over a radio interface to a radio access network node (also referred to as a base station) and/or to receive communications through transceiver circuitry 201 from a RAN node over a radio interface. Moreover, modules may be stored in memory circuitry 205, and these modules may provide instructions so that when instructions of a module are executed by processing circuitry 203, processing circuitry 203 performs respective operations (e.g., operations discussed below with respect to Example Embodiments relating to SL UEs). According to some embodiments, a SL UE 100, 102 and/or an element(s)/function(s) thereof may be embodied as a virtual node/nodes and/or a virtual machine/machines.

FIG. 2 is a block diagram illustrating elements of a radio access network RAN node 104 (also referred to as a network node, base station, eNodeB/eNB, gNodeB/gNB, etc.) of a Radio Access Network (RAN) configured to provide cellular communication according to embodiments of inventive concepts. (RAN node 104 may be provided, for example, as discussed below with respect to network node 710A, 710B of FIG. 7, network node 900 of FIG. 9, hardware 1104 or virtual machine 1108A, 1108B of FIG. 11, and/or base station 1204 of FIG. 12, all of which should be considered interchangeable in the examples and embodiments described herein and be within the intended scope of this disclosure, unless otherwise noted.) As shown, the RAN node may include transceiver circuitry 301 (also referred to as a transceiver, e.g., corresponding to portions of RF transceiver circuitry 912 and radio front end circuitry 918 of FIG. 9) including a transmitter and a receiver configured to provide uplink and downlink radio communications with mobile terminals. The RAN node may include network interface circuitry 307 (also referred to as a network interface, e.g., corresponding to portions of communication interface 906 of FIG. 9) configured to provide communications with other nodes (e.g., with other base stations) of the RAN and/or core network CN. The network node may also include processing circuitry 303 (also referred to as a processor, e.g., corresponding to processing circuitry 902 of FIG. 9) coupled to the transceiver circuitry, and memory circuitry 305 (also referred to as memory, e.g., corresponding to memory 904 of FIG. 9) coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that a separate memory circuitry is not required.

As discussed herein, operations of the RAN node may be performed by processing circuitry 303, network interface 307, and/or transceiver 301. For example, processing circuitry 303 may control transceiver 301 to transmit downlink communications through transceiver 301 over a radio interface to one or more SL UEs and/or to receive uplink communications through transceiver 301 from one or more SL UEs over a radio interface. Similarly, processing circuitry 303 may control network interface 307 to transmit communications through network interface 307 to one or more other network nodes and/or to receive communications through network interface from one or more other network nodes. Moreover, modules may be stored in memory 305, and these modules may provide instructions so that when instructions of a module are executed by processing circuitry 303, processing circuitry 303 performs respective operations (e.g., operations discussed below with respect to Example Embodiments relating to RAN nodes). According to some embodiments, RAN node 104 and/or an element(s)/function(s) thereof may be embodied as a virtual node/nodes and/or a virtual machine/machines.

According to some other embodiments, a network node may be implemented as a core network CN node without a transceiver. In such embodiments, transmission to a SL UE 100, 102 may be initiated by the network node so that transmission to the SL UE 100, 102 is provided through a network node including a transceiver (e.g., through a base station or RAN node). According to embodiments where the network node is a RAN node including a transceiver, initiating transmission may include transmitting through the transceiver.

As previously indicated, a HARQ-based Sidelink RLF detection procedure is used to detect Sidelink RLF based on a number of consecutive DTX on PSFCH reception occasions for a PC5-RRC connection. In this procedure, via RRC, a sl-maxNumConsecutiveDTX parameter us configured to control HARQ-based SL RLF detection. This parameter is a maximum number of consecutive discontinuous transmissions (DTX) that is allowed before a SL RLF is declared. In other words, a SL RLF is declared when the number of consecutive DTX reaches the maximum number.

In addition, a numConsecutiveDTX variable is used to track the number of consecutive DTX for each PC5-RRC connection. A numConsecutiveDTX UE variable is used for SL RLF detection. The Sidelink HARQ Entity shall (re-) initialize numConsecutiveDTX to zero for each PC5-RRC connection which has been established by upper layers, if any, upon establishment of the PC5-RRC connection or (re) configuration of sl-maxNumConsecutiveDTX.

The Sidelink HARQ Entity shall for each PSFCH reception occasion associated to the PSSCH transmission:
1> if PSFCH reception is absent on the PSFCH reception occasion:
   2> increment numConsecutiveDTX by 1;
   2> if numConsecutiveDTX reaches sl-max NumConsecutiveDTX:
      3> indicate HARQ-based Sidelink RLF detection to RRC.
1> else:
   2> re-initialize numConsecutiveDTX to zero.

In the various embodiments described below, methods are described for a SL UE configured with SL CA to handle SL RLF per SL carrier. In the various embodiments, the SL UE monitors radio channel quality, radio link control (RLC) retransmission and/or HARQ DTX per SL carrier. The SL UE declares SL RLF per SL carrier instead of for the whole SL CA. The SL UE then reports SL RLF to its peer UE using other SL carriers that are not failed and if connected to a gNB, reports the SL RLF to the gNB using the Uu interface. The gNB (or the peer UE) inform the UE and/or its peer UE to perform recovery actions.

In some embodiments of inventive concepts, the SL UE may declare SL RLF for the PC5-RRC connection if the number of SL carriers on which SL RLF has been detected is over a configured threshold.

In the description that follows, the various embodiments of inventive concepts refer to a NR radio access technology (RAT), but can be applied to LTE RAT and any other RAT enabling the direct transmission between two (or more) nearby devices without any loss of meaning. Methods described are applicable to SL UEs with SL unicast transmission.

A SL UE is configured with SL CA towards a peer UE, means that the UE is configured with multiple SL carriers for its SL transmissions or receptions. So the UE can aggregate these SL carriers together for its SL transmissions or receptions. The UE would be able to perform transmissions or receptions according to at least one of the following modes:
The UE may only use one of the SL carriers to perform SL transmission or reception.
The UE may use multiple SL carriers of the configured SL carriers simultaneously to perform SL transmission or reception. A transmission or reception on a SL carrier may be fully or partially overlapping in time domain with another transmission or reception on another SL carrier.

The UE maintains one PC5-RRC connection for all configured SL carriers. The PC5 connection is established on one of the SL carriers.

In a first embodiment of inventive concepts, for a SL UE configured with SL CA, an SL RLF event is declared on a SL carrier among all configured SL carriers if at least one of the below conditions is met.
1) a maximum number of out of sync on the link instances has been reached.

The SL UE may monitor the radio channel quality based on a specific reference symbol. The SL UE compares the measured channel quality with the out-of-sync and in-sync thresholds, Qout and Qin respectively. The physical channel evaluates the channel quality and periodically sends indication on out-of-sync or in-sync to layer 3. The layer 3 then evaluates, if the radio link failure based on the in-sync and out-of-sync indications, that output from the layer 3 filter. For RLM on the link, a counter and/or a timer may be defined. In an example, when the consecutively received out-of-sync indications are beyond a configured counter, a timer is started. While the timer is running, the radio link considered to be recovered if the SL UE consecutively receives a configured number of in-sync indications from the physical layer.
2) a maximum number of RLC retransmissions has been reached. In this case, the SL UE needs to trace RLC retransmission per SL carrier. The UE needs to maintain separate counters to store the number of RLC retransmissions for different carriers.
3) a configuration or reconfiguration error occurs upon reception of a RRC configuration/reconfiguration signaling message
4) a maximum number of consecutive HARQ DTX has been reached.
5) No expected acknowledgement received by the peer SL UE upon a timer has expired. This is for instance the case on when the SL UE sends an RRCReconfigurationSidelink message but do not receive a RRCReconfigurationSidelinkComplete message in response by the peer SL UE within a certain time “T”.
6) the SL UE does not get an acknowledgement on the RLC transmission within a certain amount of time T. This means that the SL UE keep on retransmitting RLC PDUs as far as a timer T is running and if it gets to ack from the peer SL UE, it declares RLF.

In a second embodiment of inventive concepts, for a SL UE configured with SL CA, the SL UE declares a HARQ-based SL RLF (i.e., an SL RLF event triggered based on monitoring of HARQ DTX) via one of the following options.

Option 1: RRC configures the following parameter to control HARQ-based Sidelink RLF detection for each SL carrier among all configured SL carriers: sl-maxNumConsecutiveDTX

The SL UE uses the following UE variable for HARQ-based Sidelink RLF detection for each SL carrier among all configured SL carriers: numConsecutiveDTX, which is maintained for each SL carrier.

In this option, different SL carriers may be associated with different settings of the parameter sl-maxNumConsecutiveDTX

For a SL carrier, the SL UE declares a HARQ-based SL RLF for the carrier when the UE variable numConsecutiveDTX of the SL carrier has reached sl-maxNumConsecutiveDTX: configured for the SL carrier

Option 2: the SL UE maintains a common RRC parameter sl-maxNumConsecutiveDTX and a common UE variable numConsecutiveDTX, for all configured SL carriers.

In addition, the SL UE is also configured with a threshold indicating a number of consecutive DTX for each SL carrier. The SL UE declares HARQ-based SL RLF for the PC5-connection only when all of the following conditions are met:
For each SL carrier, the number of detected consecutive DTX on that carrier has reached the threshold of that carrier, and
The number of consecutive DRX (discontinuous reception) on all carriers i.e., counted by the UE variable numConsecutiveDTX has reached sl-maxNumConsecutiveDTX.

Alternatively, the SL UE is also configured with a threshold for each SL carrier indicating a percentage or ratio of total number of consecutive DTX detected on all carriers. The SL UE declares HARQ-based SL RLF for the PC5-connection only when all of the following conditions are met:
For each SL carrier, the number of detected consecutive DTX on that carrier has reached the configured percentage or ratio of total number of consecutive DTX detected on all carriers.
The number of consecutive DRX on all carriers i.e., counted by the SL UE variable numConsecutiveDTX has reached sl-maxNumConsecutiveDTX

In a third embodiment of inventive concepts, for a SL UE configured with SL CA towards a peer SL UE, the SL UE may declare SL RLF for the PC5-connection between the SL UE and its peer SL UE, when at least one of the following conditions is met:
The SL UE declares SL RLF on the carrier on which the PC5-connection is established
The number of SL carriers on which SL RLF has been declared is above a configured number
   For example, if the SL UE is configured with N SL carriers, while the configured number is M (M<=N).
The SL UE declares SL RLF on all the configured carriers
   Alternatively, the UE declares SL RLF if the RLF is detected on all the carriers. Optionally, SL RLF continues to be present for a configured timer T.

In a fourth embodiment of inventive concepts, for a SL UE configured with SL CA, upon declaration of SL RLF for at least one SL carrier among all configured SL carriers as described in the first or the second embodiment, the SL UE may send a signaling to the gNB (if the LS UE is connected to the gNB) informing the gNB of the occurrence of SL RLF on the SL carrier.

The signaling may contain at least one of the following information.

If the SL RLF is declared for one or multiple SL carriers, at least one of the following information is included:
SL UE ID
The indices of one or multiple SL carriers
An indicator indicating that SL RLF has been declared for the carriers.
The RLF cause (i.e., any cause as described in the first embodiment). There may be different RLF causes, wherein different causes are associated with different carriers.

If the SL RLF is declared for the PC5-RRC connection, at least one of the following information is included:
UE ID.
Indices of all SL carriers associated with the PC5-RRC connection.
An indicator indicating that SL RLF has been detected for the PC5-RRC connection
The RLF cause (i.e., any cause as described in the first embodiment). There may be different RLF causes, wherein different causes are associated with different carriers.

For any one of the above options, the SL UE sends the signaling to the gNB via at least one of the following signaling alternatives

Alt. 1: dedicated RRC signaling, which may be an existing RRC signaling or a new RRC signaling.

Alt. 2: MAC CE based signaling, which may be an existing MAC CE or a new MAC CE for indicating that the UE has declared/detected SL RLF.

Alt. 3: the UE initiates a RACH procedure to carry the signaling.

A 4-step RA can be triggered to carry the signaling.

In an example, Msg1 is used to carry the signaling. A dedicated preamble or

dedicated RACH occasions may be allocated to the UE for indicating the above signaling information. The allocation may be pre-defined, determined based on a pre-defined rule, or configured by another node.

In an example, Msg3 is extended to carry the signaling information. In Msg3, the SL UE MAC entity adds an indicator indicating the above signaling information. The indicator may be a field in the MAC subheader or carried in a MAC CE.

A 2-step RA can be triggered to carry the signaling. A dedicated preamble or dedicated RACH occasions or dedicated PUSCH occasions/resources may be allocated to the UE for indicating the signaling information. Alternatively, indicators can be included in MsgA payload. The indicator may be a field in the MAC subheader or carried in a MAC CE.

Alternatively, an RRC message (partly or fully) may be included in a RACH message, which includes the above signaling information from the SL UE.

Alt. 4: the SL UE initiates a PUCCH transmission for indicting the signaling information. Separate dedicated PUCCH resources may be configured accordingly.

Alt. 5: the UE initiates a configured grant-based transmission for carrying the signaling. Separate dedicated configured grant resources may be configured accordingly. Alternatively, the signaling information may be included in the configured grant-uplink control information (CG-UCI).

Alt. 6: the SL UE initiates an SRS transmission for indicting signaling information. Separate dedicated SRS resources may be configured accordingly.

Specifically, as an additional example to Alt. 4 and Alt. 5, the SL UE can transmit the signaling in the PUCCH-UCI which can be carried in the PUCCH or multiplexed with PUSCH.

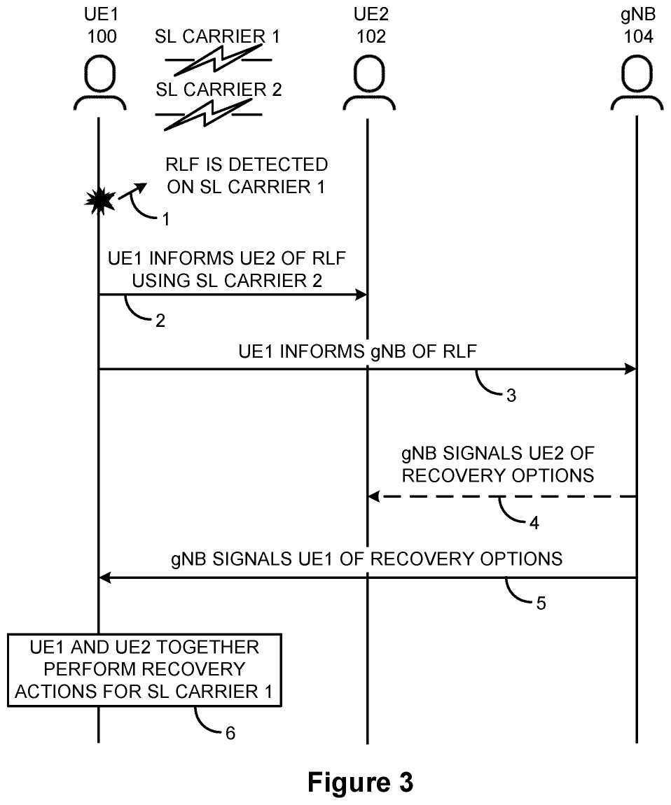

An example of SL RLF handling is illustrated in FIG. 3.

Turning to FIG. 3, in operation 1, the UE1 100 detects RLF on SL carrier 1. In operation 2, the UE1 100 informs UE2 102 of the RLF using SL carrier 2.

In operation 3, the UE1 100 informs the gNB 104 of the RLF. In operation 4, the gNB 104 optionally signals UE2 102 of recovery options. In operation 5, the gNB 104 signals UE1 100 of recovery options.

In operation 6, UE1 100 and UE2 102 together perform recovery actions for SL carrier 1. In other embodiments UE1 100 or UE2 102 perform recovery actions.

In a fifth embodiment of inventive concepts, for a SL UE configured with SL CA towards a peer SL UE, upon detection of SL RLF for a SL carrier among all configured SL carriers, the SL UE performs at least one of the following actions to recover from the SL RLF for the carrier. These actions may be as a result of the gNB sending recovery options to the SL UE. The actions include:
Deactivate the SL carrier. In addition, if the SL UE has established the PC5-RRC connection on the SL carrier, the SL UE may deactivate all other SL carriers managed/controlled under the PC5-RRC connection. Deactivation of a SL carrier is a temporary state. In other words, the SL carrier may be reactivated again after a period of time.
De-configure the SL carrier. In addition, if the SL UE has established the PC5-RRC connection on the SL carrier, the SL UE may de-configure all other SL carriers managed/controlled under the PC5-RRC connection. Deconfiguration of a SL carrier is a hard decision. In other words, the SL carrier will not be configured for the SL UE.
Adding a new SL carrier to replace the SL carrier on which SL RLF has been detected
Informing the SL RLF to its peer SL UE via other SL carriers which are still active
Reconfigure the SL carrier. For example, adding or configure a new SL bandwidth part (BWP) for the SL carrier, meanwhile deactivate or de-configure the SL BWP on which SL RLF is detected.
Tear down the PC5-RRC connection for the SL UE.
Reconfigure or reestablish the PC5-RRC connection for the SL UE
Deactivate CA for the PC5 connection between the two SL UEs (e.g., UE1 100 and UE2 102 in FIG. 1). This means that the SL UE will pick one SL carrier among the ones configured for CA and release the rest of the carriers. In this case, the SL connection will start to operate normally without using CA.

The SL UE signals its peer SL UE of the SL RLF via at least one of the following signaling alternatives:
PC5-S signaling
PC5-RRC signaling
MAC CE
L1 signaling on physical channels such as PSSCH, PSCCH, PSFCH etc.

The signaling may carry at least one of the following information:
identifiers of one or multiple SL carriers on which SL RLF have been detected
   in an example, a bitmap field containing multiple bits may be defined in the signaling. Each bit represents a specific SL carrier (e.g., the bit position equals to the index of the SL carrier). The bit with the value ‘1’ indicates that SL RLF has been detected for the associated SL carrier, while the bit with the value ‘0’ indicates that SL RLF has not been detected for the associated SL carrier.
RLF cause for each concerned SL carrier (i.e., any cause as described in the first embodiment). There may be different RLF causes, wherein different causes are associated with different carriers.
UE preferred actions for the SL carriers on which SL RLF have been detected, such as:
   deactivation of the SL carriers or
   deconfiguration of the SL carriers

In a sixth embodiment of inventive concepts, upon reception of the signaling from a SL UE indicating detection of SL RLF for a SL carrier in case of SL CA, the gNB may send a signaling to the SL UE informing the SL UE of at least one of the following actions.
Deactivate the SL carrier. In addition, if the SL UE has established the PC5-RRC connection on the SL carrier, the SL UE may deactivate all other SL carriers managed/controlled under the PC5-RRC connection. Deactivation of a SL carrier is a temporary state. In other words, the SL carrier may eventually be reactivated.
De-configure the SL carrier. In addition, if the SL UE has established the PC5-RRC connection on the SL carrier, the SL UE may de-configure all other SL carriers managed/controlled under the PC5-RRC connection. Deconfiguration of a SL carrier is a hard decision. In other words, the SL carrier will not be configured for the SL UE.
Adding a new SL carrier to replace the SL carrier on which SL RLF has been detected
Informing the SL RLF to its peer SL UE via dedicated RRC signaling, MAC CE or L1 signaling (e.g., DCI). If the peer SL UE is belonging to another gNB, the signaling will be sent to the other gNB first. The other gNB informs the peer SL UE via dedicated RRC signaling, MAC CE or L1 signaling (e.g., DCI).
Reconfigure the SL carrier. For example, adding or configure a new SL bandwidth part (BWP) for the SL carrier, meanwhile deactivate or de-configure the SL BWP on which SL RLF is detected.
Tear down the PC5-RRC connection for the SL UE.
Reconfigure or reestablish the PC5-RRC connection for the SL UE
Deactivate CA for the PC5 connection between the two SL UEs (e.g., UE1 100 and UE2 102 in FIG. 1). This means that the gNB will configure one SL carrier among the ones configured for CA and release the rest of the carriers. In this case, the SL connection will start to operate normally without using CA.

The gNB may send the signaling to the SL UE via at least one of the following signaling alternatives:
System information
Dedicated RRC signaling
MAC CE
L1 signaling such as DCI

The signaling may carry at least one of the following information:
identifiers of one or multiple SL carriers which need to be deactivated or de-configured
indicators of one or multiple SL carriers which need to be added.

Upon detection of SL RLF for a SL carrier, if the SL UE sends the signaling to the gNB informing the gNB of the SL RLF, the SL UE will not perform recovery actions by itself (as described above in the fourth embodiment), the SL UE will wait for signaling or instruction from the gNB for further actions such as performing recovery actions.

The gNB may also signal the peer SL UE of RLF and also potential recovery actions. In this case, the SL UE together with its peer SL UE perform recovery actions for the concerned SL carriers.

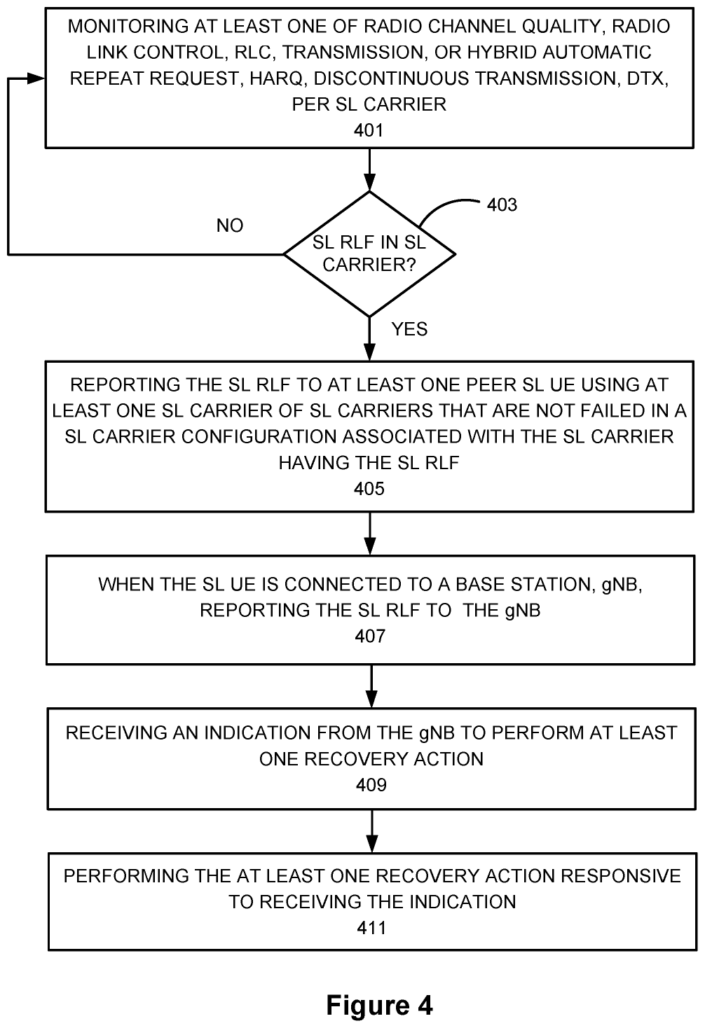

In the description that follows, while the SL UE may be any of the SL UE 100, 102, wireless device 712A, 712B, wired or wireless devices UE 712C, UE 712D, UE 800, virtualization hardware 1104, virtual machines 1108A, 1108B, or UE 1206, the SL UE 100 shall be used to describe the functionality of the operations of the SL UE. Operations of the SL UE 100 (implemented using the structure of the block diagram of FIG. 2) will now be discussed with reference to the flow chart of FIG. 4 according to some embodiments of inventive concepts. For example, modules may be stored in memory 205 of FIG. 2, and these modules may provide instructions so that when the instructions of a module are executed by respective communication device processing circuitry 203, processing circuitry 203 performs respective operations of the flow chart.

FIG. 4 illustrates operations of the SL UE 100 according to some embodiments of inventive concepts. Turning to FIG. 4, in block 401, the processing circuitry 203 monitors at least one of radio channel quality, radio link control, RLC, transmission, or hybrid automatic repeat request, HARQ, discontinuous transmission, DTX, per SL carrier.

In block 403, the processing circuitry 203 determines there is a SL RLF in a SL carrier. In some embodiments of inventive concepts, the processing circuitry 203 determines there is the SL RLF in the SL carrier responsive to at least one condition being met. In some of these embodiments, the at least one condition includes at least one of: a maximum number of out-of-sync on link instances has been reached; a maximum number of RLC retransmissions has been reached; a configuration error or a reconfiguration error occurs upon reception of a RRC configuration/reconfiguration signaling message; a maximum number of consecutive HARQ DTX has been reached; no expected acknowledgement received by the peer UE upon a timer has expired; and an acknowledgement on an RLC transmission has not been received within a certain amount of time.

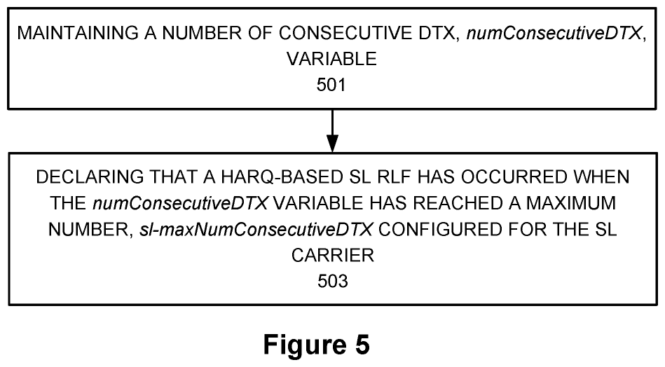

In other embodiments of inventive concepts as illustrated in the flowchart of FIG. 5, the processing circuitry 203 determines there is a SL RLF in a SL carrier by, for each SL carrier, maintaining, in block 501, a number of consecutive DTX, numConsecutiveDTX, variable. In block 503, the processing circuitry 203 declares that a HARQ-based SL RLF has occurred when the numConsecutiveDTX variable has reached a maximum number, sl-maxNumConsecutiveDTX configured for the SL carrier.

In other embodiments of inventive concepts, the processing circuitry 203 determines there is a SL RLF in the SL carrier by maintaining a common RRC maximum number parameter, sl-maxNumConsecutiveDTX, and a common UE variable, numConsecutiveDTX, for all configured SL carriers and maintaining a threshold indicating a number of consecutive DTX for each SL carrier. The processing circuitry 203 declares a SL RLF for a PC5-connection responsive to: for each SL carrier, the number of consecutive DTX on that carrier has reached the threshold of that carrier; and a number of consecutive DRX on all carriers counted by the UE variable numConsecutiveDTX has reached sl-maxNumConsecutiveDTX.

In further embodiments of inventive concepts, the processing circuitry 203 determines there is a SL RLF in the SL carrier by maintaining a threshold for each SL carrier indicating one of a percentage or ratio of total number of consecutive DTX detected on all carriers and declaring a SL RLF for a PC5-connection responsive to: for each SL carrier, the number of detected consecutive DTX on that carrier has reached the one of the percentage or ratio of the total number of consecutive DTX detected on all carriers; and the number of consecutive DRX on all carriers counted by the UE variable numConsecutiveDTX has reached sl-maxNumConsecutiveDTX.

In yet other embodiments of inventive concepts, the processing circuitry 203 determines there is a SL RLF in the SL carrier by declaring that there is a SL RLF for a PC5 connection when at least one of: a SL RLF on a carrier on which the PC5-connection is established has been declared; a number of SL carriers on which SL RLF has been declared is above a configured number; and a SL RLF is declared on all configured carriers.

Returning to FIG. 4, the processing circuitry 203, for each SL carrier, responsive to determining there is a SL RLF in the SL carrier, reports, in block 405, SL RLF to at least one peer SL UE using at least one SL carrier of SL carriers that are not failed in a SL carrier configuration associated with the SL carrier having the SL RLF, and in block 407, when the SL UE is connected to a base station, gNB, reports the SL RLF to the gNB.

In various embodiments of inventive concepts, the processing circuitry 203, when the SL UE is connected to the gNB, reports the SL RLF to the gNB, by sending signaling to the gNB informing the gNB of the occurrence of SL RLF on the SL carrier wherein the signaling contains at least one of: when the SL RLF is declared for one or multiple SL carriers, including at least one of: an identifier, ID, of the SL UE; indices of the one or multiple SL carriers; a first indicator indicating that SL RLF has been declared for the one or multiple carriers; and at least an RLF cause when the RLF cause is known. When the SL RLF is declared for a PC5-RRC connection, the signaling includes at least one of: an identifier, ID, of the SL UE; indices of all SL carriers associated with the PC5-RRC connection; a second indicator indicating that SL RLF has been detected for the PC5-RRC connection; and at least an RLF cause when the RLF cause is known

In the various embodiments of inventive concepts, the processing circuitry 203 sends the signaling to the gNB by sending the signaling to the gNB via at least one of: dedicated RRC signaling; medium access control, MAC, control element, CE, based signaling; a random access channel, RACH, procedure initiated at the SL UE; a physical uplink control channel, PUCCH, transmission; a configured grant-based transmission for carrying the signaling; and a sounding reference signal, SRS, transmission.

In block 409, the processing circuitry 203 receives an indication from the gNB to perform at least one recovery action. In block 411, the processing circuitry 203 performs the at least one recovery action responsive to receiving the indication.

In some other embodiments of inventive concepts, the processing circuitry 203 performs the at least one recovery action by performing at least one of: deactivating the SL carrier responsive to the SL UE having established the PC5-RRC connection on the SL carrier; de-configuring the SL carrier responsive to the SL UE having established the PC5-RRC connection on the SL carrier; adding a SL carrier to replace the SL carrier on which the SL RLF has been detected; informing the SL RLF to a peer SL UE via other SL carriers that remain active; reconfiguring the SL carrier; tearing down the PC5-RRC connection for the UE; reconfiguring or reestablishing the PC5-RRC connection for the SL UE; and de-activating CA for the PC5 connection between the two SL UEs.

In these other embodiments, the processing circuitry 203 informs the SL RLF to the peer SL UE by signaling the peer SL UE of the SL RLF via at least one of: PC5-S signaling; PC5-RRC signaling; MAC CE; and L1 signaling on physical channels.

In some embodiments of signaling the peer SL UE, the processing circuitry 203 signal the peer SL UE by carrying at least one of: identifiers of one or more SL carriers on which SL RLF have been detected; an RLF cause for each of the one or more SL carriers; and SL UE preferred actions for the one or more SL carriers on which SL RLF have been detected.

Various operations from the flow chart of FIG. 4 may be optional with respect to some embodiments of communication devices and related methods. Regarding methods of example embodiment 1 (set forth below), for example, operations of blocks 409 and 411 of FIG. 4 may be optional.

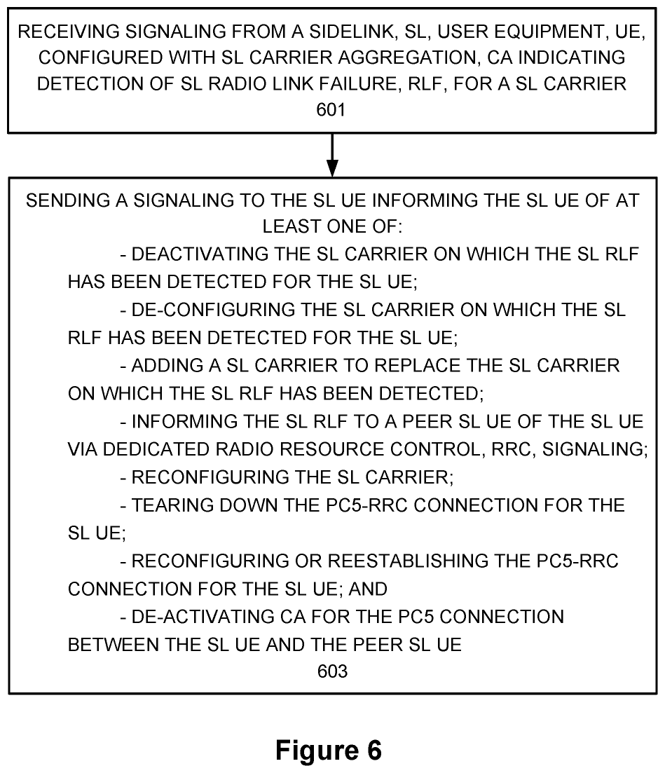

In the description that follows, while the network node may be any of the RAN node 104, network node 710A, 710B, 900, 1206, hardware 1104, or virtual machine 1108A, 1108B, the RAN node 104 shall be used to describe the functionality of the operations of the network node. Operations of the RAN node 104 (implemented using the structure of FIG. 3) will now be discussed with reference to the flow chart of FIG. 6 according to some embodiments of inventive concepts. For example, modules may be stored in memory 305 of FIG. 3, and these modules may provide instructions so that when the instructions of a module are executed by respective RAN node processing circuitry 303, processing circuitry 303 performs respective operations of the flow chart.

FIG. 6 illustrates operations of the RAN node 104.

Turning to FIG. 6, in block 601, the processing circuitry 303 receives signaling from a sidelink, SL, user equipment, UE, (100, 102, 712A, 712B, 712C, 712D, 800, 1104, 1108A, 1108B, 1206) configured with SL carrier aggregation, CA indicating detection of SL radio link failure, RLF, for a SL carrier.

In block 603, the processing circuitry 303 sends a signaling to the SL UE (100, 102, 712A, 712B, 712C, 712D, 800, 1104, 1108A, 1108B, 1206) informing the SL UE of at least one of: deactivating the SL carrier on which the SL RLF has been detected for the SL UE; de-configuring the SL carrier on which the SL RLF has been detected for the SL UE; adding a SL carrier to replace the SL carrier on which the SL RLF has been detected; informing the SL RLF to a peer SL UE of the SL UE via dedicated radio resource control, RRC, signaling; reconfiguring the SL carrier; tearing down the PC5-RRC connection for the SL UE; reconfiguring or reestablishing the PC5-RRC connection for the SL UE; and de-activating CA for the PC5 connection between the SL UE and the peer SL UE.

In some embodiments of inventive concepts, the processing circuitry 303 sends the signaling by sending the signaling via at least one of: system information; dedicated RRC signaling; medium access control, MAC, control element, CE; and L1 signaling.

In some of these embodiments, the processing circuitry 303 sends the signaling carrying at least one of: identifiers of one or multiple SL carriers which need to be deactivated or de-configured; and indicators of one or multiple SL carriers which need to be added.

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

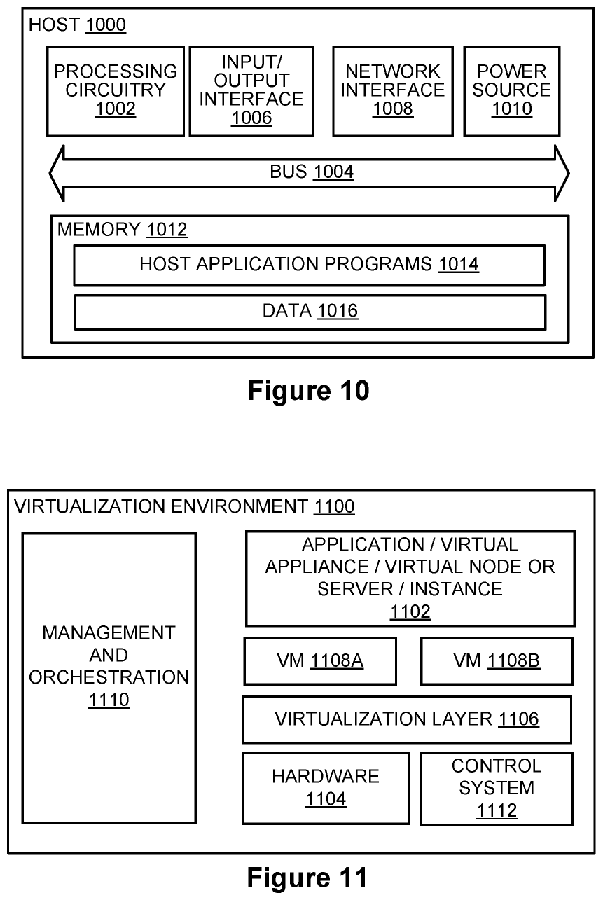

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### Embodiments

1. A method in a sidelink, SL, user equipment, UE, (100, 102, 712A, 712B, 712C, 712D, 800, 1104, 1108A, 1108B, 1206) configured with SL carrier aggregation, CA, to handle SL radio link failure, RLF, per SL carrier, the method comprising:
   monitoring (401) at least one of radio channel quality, radio link control, RLC, transmission, or hybrid automatic repeat request, HARQ, discontinuous transmission, DTX, per SL carrier;
   for each SL carrier, responsive to determining (403) there is a SL RLF in the SL carrier:
      reporting (405) SL RLF to at least one peer SL UE using at least one SL carrier of SL carriers that are not failed in a SL carrier configuration associated with the SL carrier having the SL RLF; and
      when the SL UE is connected to a base station, gNB, reporting (407) the SL RLF to the gNB.
2. The method of Embodiment 1, further comprising determining (403) there is a SL RLF in the SL carrier.
3. The method of Embodiment 2, wherein determining there is the SL RLF in the SL carrier responsive to at least one condition being met.
4. The method of Embodiment 3 wherein the at least one condition comprises at least one of:
   a maximum number of out-of-sync on link instances has been reached;
   a maximum number of RLC retransmissions has been reached;
   a configuration error or a reconfiguration error occurs upon reception of a RRC configuration/reconfiguration signaling message;
   a maximum number of consecutive HARQ DTX has been reached;
   no expected acknowledgement received by the peer UE upon a timer has expired; and
   an acknowledgement on an RLC transmission has not been received within a certain amount of time.
5. The method of Embodiment 2, wherein determining there is a SL RLF in the SL carrier comprises:
   for each SL carrier:
      maintaining (501) a number of consecutive DTX, numConsecutiveDTX, variable; and
      declaring (503) that a HARQ-based SL RLF has occurred when the numConsecutiveDTX variable has reached a maximum number, sl-maxNumConsecutiveDTX configured for the SL carrier.
6. The method of Embodiment 5 wherein the sl-maxNumConsecutiveDTX comprises a different setting for at least two SL carriers.
7. The method of Embodiment 2, wherein determining there is a SL RLF in the SL carrier comprises:
   maintaining a common RRC maximum number parameter, sl-maxNumConsecutiveDTX, and a common UE variable, numConsecutiveDTX, for all configured SL carriers;
   maintaining a threshold indicating a number of consecutive DTX for each SL carrier;
   declaring a SL RLF for a PC5-connection responsive to:
      for each SL carrier, the number of consecutive DTX on that carrier has reached the threshold of that carrier; and
      a number of consecutive DRX on all carriers counted by the UE variable numConsecutiveDTX has reached sl-maxNumConsecutiveDTX.
8. The method of Embodiment 2, wherein determining there is a SL RLF in the SL carrier comprises:
   maintaining a threshold for each SL carrier indicating one of a percentage or ratio of total number of consecutive DTX detected on all carriers; and
   declaring a SL RLF for a PC5-connection responsive to:
      for each SL carrier, the number of detected consecutive DTX on that carrier has reached the one of the percentage or ratio of the total number of consecutive DTX detected on all carriers; and
      the number of consecutive DRX on all carriers counted by the UE variable numConsecutiveDTX has reached sl-maxNumConsecutiveDTX.
9. The method of Embodiment 2, wherein determining there is a SL RLF in the SL carrier comprises declaring that there is a SL RLF for a PC5 connection when at least one of:
   a SL RLF on a carrier on which the PC5-connection is established has been declared;
   a number of SL carriers on which SL RLF has been declared is above a configured number; and
   a SL RLF is declared on all configured carriers.
10. The method of any of Embodiments 1-9, wherein reporting the SL RLF to the gNB, via an interface comprises sending signaling to the gNB informing the gNB of the occurrence of SL RLF on the SL carrier wherein the signaling contains at least one of:
   when the SL RLF is declared for one or multiple SL carriers, including at least one of:
      an identifier, ID, of the SL UE;
      indices of the one or multiple SL carriers;
      a first indicator indicating that SL RLF has been declared for the one or multiple carriers; and
      at least an RLF cause when the RLF cause is known; and
   when the SL RLF is declared for a PC5-RRC connection, including at least one of:
      an identifier, ID, of the SL UE;
      indices of all SL carriers associated with the PC5-RRC connection;
      a second indicator indicating that SL RLF has been detected for the PC5-RRC connection; and
      at least an RLF cause when the RLF cause is known.
11. The method of Embodiment 10, wherein sending the signaling to the gNB comprises sending the signaling to the gNB via at least one of:
   dedicated RRC signaling;
   medium access control, MAC, control element, CE, based signaling;
   a random access channel, RACH, procedure initiated at the SL UE;
   a physical uplink control channel, PUCCH, transmission;
   a configured grant-based transmission for carrying the signaling; and
   a sounding reference signal, SRS, transmission.
12. The method of any of Embodiments 1-11, further comprising:
   receiving (409) an indication from the gNB to perform at least one recovery action; and
   performing (411) the at least one recovery action responsive to receiving the indication.
13. The method of Embodiment 12, wherein performing the at least one recovery action comprises performing at least one of:
   deactivating the SL carrier responsive to the SL UE having established the PC5-RRC connection on the SL carrier;
   de-configuring the SL carrier responsive to the SL UE having established the PC5-RRC connection on the SL carrier;
   adding a SL carrier to replace the SL carrier on which the SL RLF has been detected;
   informing the SL RLF to a peer SL UE via other SL carriers that remain active;
   reconfiguring the SL carrier;
   tearing down the PC5-RRC connection for the SL UE;
   reconfiguring or reestablishing the PC5-RRC connection for the SL UE; and
   de-activating CA for the PC5 connection between the two SL UEs.
14. The method of Embodiment 13 wherein informing the SL RLF to the peer SL UE comprises signaling the peer SL UE of the SL RLF via at least one of:
   PC5-S signaling;
   PC5-RRC signaling;
   MAC CE; and
   L1 signaling on physical channels.
15. The method of Embodiment 14 wherein signaling the peer SL UE comprises carrying at least one of:
   identifiers of one or more SL carriers on which SL RLF have been detected;
   an RLF cause for each of the one or more SL carriers; and
   SL UE preferred actions for the one or more SL carriers on which SL RLF have been detected.
16. A method in a base station (104, 710A, 710B, 900, 1104, 1108A, 1108B, 1204) comprising:
   receiving (601) signaling from a sidelink, SL, user equipment, UE, configured with SL carrier aggregation, CA indicating detection of SL radio link failure, RLF, for a SL carrier;
   sending (603) a signaling to the SL UE informing the SL UE of at least one of:
      deactivating the SL carrier on which the SL RLF has been detected for the SL UE;
      de-configuring the SL carrier on which the SL RLF has been detected for the SL UE;
      adding a SL carrier to replace the SL carrier on which the SL RLF has been detected;
      informing the SL RLF to a peer SL UE of the SL UE via dedicated radio resource control, RRC, signaling;
      reconfiguring the SL carrier;
      tearing down the PC5-RRC connection for the SL UE;
      reconfiguring or reestablishing the PC5-RRC connection for the SL UE; and
      de-activating CA for the PC5 connection between the SL UE and the peer SL UE.
17. The method of Embodiment 16, wherein sending the signaling comprises sending the signaling via at least one of:
   system information;
   dedicated RRC signaling;
   medium access control, MAC, control element, CE; and
   L1 signaling.
18. The method of any of Embodiments 16-17, wherein sending the signaling comprises sending the signaling carrying at least one of:
   identifiers of one or multiple SL carriers which need to be deactivated or de-configured; and
   indicators of one or multiple SL carriers which need to be added.
19. A sidelink, SL, user equipment, UE, (100, 102, 712A, 712B, 712C, 712D, 800, 1104, 1108A, 1108B, 1206) configured with SL carrier aggregation, CA, to handle SL radio link failure, RLF, per SL carrier, the SL UE adapted to:
   monitor (401) at least one of radio channel quality, radio link control, RLC, transmission, or hybrid automatic repeat request, HARQ, discontinuous transmission, DTX, per SL carrier;
   for each SL carrier, responsive to determining (403) there is a SL RLF in the SL carrier, wherein a sidelink RLF failure is determined based on a number of consecutive discontinuous transmission failures:
      report (405) SL RLF to at least one peer SL UE using at least one SL carrier of SL carriers that are not failed in a SL carrier configuration associated with the SL carrier having the SL RLF; and
      when the SL UE is connected to a base station, gNB, report (407) the SL RLF to the gNB.
20. The SL UE of Embodiment 19, wherein the SL UE is further adapted to determine (403) there is a SL RLF in the SL carrier.
21. The SL UE of Embodiment 20, wherein determining there is the SL RLF in the SL carrier responsive to at least one condition being met.
22. The SL UE of Embodiment 21 wherein the at least one condition comprises at least one of:
   a maximum number of out-of-sync on link instances has been reached;
   a maximum number of RLC retransmissions has been reached;
   a configuration error or a reconfiguration error occurs upon reception of a RRC configuration/reconfiguration signaling message;
   a maximum number of consecutive HARQ DTX has been reached;
   no expected acknowledgement received by the peer UE upon a timer has expired; and
   an acknowledgement on an RLC transmission has not been received within a certain amount of time.
23. The SL UE of Embodiment 20, wherein determining there is a SL RLF in the SL carrier comprises:
   for each SL carrier:
      maintaining (501) a number of consecutive DTX, numConsecutiveDTX, variable; and
      declaring (503) that a HARQ-based SL RLF has occurred when the numConsecutiveDTX variable has reached a maximum number, sl-maxNumConsecutiveDTX configured for the SL carrier.
24. The SL UE of Embodiment 23 wherein the sl-maxNumConsecutiveDTX comprises a different setting for at least two SL carriers.
25. The SL UE of Embodiment 20, wherein determining there is a SL RLF in the SL carrier comprises:
   maintaining a common RRC maximum number parameter, sl-maxNumConsecutiveDTX, and a common UE variable, numConsecutiveDTX, for all configured SL carriers;
   maintaining a threshold indicating number of consecutive DTX for each SL carrier;
   declaring a SL RLF for a PC5-connection responsive to:
      for each SL carrier, the number of consecutive DTX on that carrier has reached the threshold of that carrier; and
      a number of consecutive DRX on all carriers counted by the UE variable numConsecutiveDTX has reached sl-maxNumConsecutiveDTX.
26. The SL UE of Embodiment 20, wherein determining there is a SL RLF in the SL carrier comprises:
   maintaining a threshold for each SL carrier indicating one of a percentage or ratio of total number of consecutive DTX detected on all carriers; and
   declaring a SL RLF for a PC5-connection responsive to:
      for each SL carrier, the number of detected consecutive DTX on that carrier has reached the one of the percentage or ratio of the total number of consecutive DTX detected on all carriers; and
      the number of consecutive DRX on all carriers counted by the UE variable numConsecutiveDTX has reached sl-maxNumConsecutiveDTX.
27. The SL UE of Embodiment 20, wherein determining there is a SL RLF in the SL carrier comprises declaring that there is a SL RLF for a PC5 connection when at least one of:
   a SL RLF on a carrier on which the PC5-connection is established has been declared;
   a number of SL carriers on which SL RLF has been declared is above a configured number; and
   a SL RLF is declared on all configured carriers.
28. The SL UE of any of Embodiments 19-27, wherein reporting the SL RLF to the gNB, via an interface comprises sending signaling to the gNB informing the gNB of the occurrence of SL RLF on the SL carrier wherein the signaling contains at least one of:
   when the SL RLF is declared for one or multiple SL carriers, including at least one of:
      an identifier, ID, of the SL UE
      indices of the one or multiple SL carriers;
      a first indicator indicating that SL RLF has been declared for the one or multiple carriers; and
      at least an RLF cause when the RLF cause is known; and
   when the SL RLF is declared for a PC5-RRC connection, including at least one of:
      an identifier, ID, of the SL UE
      indices of all SL carriers associated with the PC5-RRC connection;
      a second indicator indicating that SL RLF has been detected for the PC5-RRC connection; and
      at least an RLF cause when the RLF cause is known.
29. The SL UE of Embodiment 28, wherein sending the signaling to the gNB comprises sending the signaling to the gNB via at least one of:
   dedicated RRC signaling;
   medium access control, MAC, control element, CE, based signaling;
   a random access channel, RACH, procedure initiated at the SL UE;
   a physical uplink control channel, PUCCH, transmission;
   a configured grant-based transmission for carrying the signaling; and
   a sounding reference signal, SRS, transmission.
30. The SL UE of any of Embodiments 19-29, wherein the SL UE is further adapted to: receive (409) an indication from the gNB to perform at least one recovery action; and perform (411) the at least one recovery action responsive to receiving the indication.
31. The SL UE of Embodiment 30, wherein performing the at least one recovery action comprises performing at least one of:
   deactivating the SL carrier responsive to the SL UE having established the PC5-RRC connection on the SL carrier;
   de-configuring the SL carrier responsive to the SL UE having established the PC5-RRC connection on the SL carrier;
   adding a SL carrier to replace the SL carrier on which the SL RLF has been detected;
   informing the SL RLF to a peer SL UE via other SL carriers that remain active;
   reconfiguring the SL carrier;
   tearing down the PC5-RRC connection for the SL UE;
   reconfiguring or reestablishing the PC5-RRC connection for the SL UE; and
   de-activating CA for the PC5 connection between the two SL UEs.
32. The SL UE of Embodiment 31 wherein informing the SL carrier to the peer SL UE comprises signaling the peer SL UE of the SL RLF via at least one of:
   PC5-S signaling;
   PC5-RRC signaling;
   MAC CE; and
   L1 signaling on physical channels.
33. The SL UE of Embodiment 32 wherein signaling the peer SL UE comprises carrying at least one of:
   identifiers of one or more SL carriers on which SL RLF have been detected;
   an RLF cause for each of the one or more SL carriers; and
   SL UE preferred actions for the one or more SL carriers on which SL RLF have been detected.
34. A base station (104, 710A, 710B, 900, 1104, 1108A, 1108B, 1204) adapted to:
   receive (601) signaling from a sidelink, SL, user equipment, UE, configured with SL carrier aggregation, CA indicating detection of SL radio link failure, RLF, for a SL carrier;
   send (603) a signaling to the SL UE informing the SL UE of at least one of:
      deactivate the SL carrier on which the SL RLF has been detected for the SL UE;
      de-configure the SL carrier on which the SL RLF has been detected for the SL UE;
      add a SL carrier to replace the SL carrier on which the SL RLF has been detected;
      inform the SL RLF to a peer SL UE of the SL UE via dedicated radio resource control, RRC, signaling;
      reconfigure the SL carrier;
      tear down the PC5-RRC connection for the SL UE;
      reconfigure or reestablish the PC5-RRC connection for the SL UE; and
      de-activate CA for the PC5 connection between the SL UE and the peer SL UE.
35. The base station of Embodiment 34, wherein sending the signaling comprises sending the signaling via at least one of:
   system information;
   dedicated RRC signaling;
   medium access control, MAC, control element, CE; and
   L1 signaling.
36. The base station of any of Embodiments 34-35, wherein sending the signaling comprises sending the signaling carrying at least one of:
   identifiers of one or multiple SL carriers which need to be deactivated or de-configured; and
   indicators of one or multiple SL carriers which need to be added.
37. A sidelink, SL, user equipment, UE, (100, 102, 712A, 712B, 712C, 712D, 800, 1104, 1108A, 1108B, 1206) configured with SL carrier aggregation, CA, to handle SL radio link failure, RLF, per SL carrier, the SL UE comprising:
   processing circuitry (203, 802, 1112); and
   memory (205, 810) coupled with the processing circuitry, wherein the memory includes instructions that when executed by the processing circuitry causes the SL UE to perform operations according to any of Embodiments 1-15.
38. A base station (104, 710A, 710B, 900, 1104, 1108A, 1108B, 1204) comprising:
   processing circuitry (303, 902); and
   memory (305, 904) coupled with the processing circuitry, wherein the memory includes instructions that when executed by the processing circuitry causes the RAN node to perform operations according to any of Embodiments 16-18.
39. A computer program comprising program code to be executed by processing circuitry (203, 802, 1112) of a side link, SL, user equipment, UE (100, 102, 712A, 712B, 712C, 712D, 800, 1104, 1108A, 1108B, 1206), whereby execution of the program code causes the SL UE (100, 102, 712A, 712B, 712C, 712D, 800, 1104, 1108A, 1108B, 1206) to perform operations according to any of Embodiments 1-15.
40. A computer program product comprising a non-transitory storage medium including program code to be executed by processing circuitry (203, 802, 1112) of a side link, SL, user equipment, UE (100, 102, 712A, 712B, 712C, 712D, 800, 1104, 1108A, 1108B, 1206), whereby execution of the program code causes the SL UE (100, 102, 712A, 712B, 712C, 712D, 800, 1104, 1108A, 1108B, 1206) to perform operations according to any of embodiments 1-15.
41. A computer program comprising program code to be executed by processing circuitry (303, 904) of a radio access network, RAN, node (710A, 710B, 900, 1104, 1108A, 1108B, 1204), whereby execution of the program code causes the RAN node (400, 710A, 710B, 900, 1104, 1108A, 1108B, 1204) to perform operations according to any of embodiments 16-18.
42. A computer program product comprising a non-transitory storage medium including program code to be executed by processing circuitry (303, 904) of a radio access network, RAN, node (104, 710A, 710B, 900, 1104, 1108A, 1108B, 1204), whereby execution of the program code causes the RAN node (104, 710A, 710B, 900, 1104, 1108A, 1108B, 1204) to perform operations according to any of embodiments 16-18.

### REFERENCES ARE IDENTIFIED BELOW

1) 3GPP TS 38.321 v. 16.6.0 (2021-09), 3rd Generation Partnership Project; Technical Specification Group Radio Access Network; NR; Medium Access Control (MAC) protocol specification (Release 16)

1.-38. (canceled)

39. A method in a sidelink, SL, user equipment, UE, configured with SL carrier aggregation, CA, to handle SL radio link failure, RLF, per SL carrier, the method comprising:
monitoring a hybrid automatic repeat request, HARQ, discontinuous transmission, DTX, per SL carrier;
for each SL carrier, determining that a HARQ-based SL RLF has occurred when a number of consecutive DT, numConsecutiveDTX, variable has reached a maximum number, sl-maxNumConsecutiveDTX, configured for the SL carrier;
and responsive to determining there is a SL RLF in the SL carrier:
reporting SL RLF to at least one peer SL UE using at least one SL carrier of SL carriers that are not failed in a SL carrier configuration associated with the SL carrier having the SL RLF; and
reporting the SL RLF to a base station, gNB.

40. The method of claim 39, wherein determining there is a SL RLF in the SL carrier comprises declaring that there is a SL RLF for a PC5 connection when at least one of:
a SL RLF on a carrier on which the PC5-connection is established has been declared;
a number of SL carriers on which SL RLF has been declared is above a configured number; and
a SL RLF is declared on all configured carriers.

41. The method of claim 39, wherein determining there is the SL RLF in the SL carrier comprises determining there is the SL RLF in the SL carrier responsive to at least one condition being met.

42. The method of claim 41 wherein the at least one condition comprises at least one of:
a maximum number of out-of-sync on link instances has been reached;
a maximum number of RLC retransmissions has been reached;
a configuration error or a reconfiguration error occurs upon reception of a RRC configuration/reconfiguration signaling message;
a maximum number of consecutive HARQ DTX has been reached;
no expected acknowledgement received by the peer UE upon a timer has expired; and
an acknowledgement on an RLC transmission has not been received within a certain amount of time.

43. The method of claim 39, wherein determining there is a SL RLF in the SL carrier comprises:
maintaining a common RRC maximum number parameter, sl-maxNumConsecutiveDTX, and a common UE variable, numConsecutiveDTX, for all configured SL carriers;
maintaining a threshold indicating a number of consecutive DTX for each SL carrier;
declaring a SL RLF for a PC5-connection responsive to:
for each SL carrier, the number of consecutive DTX on that carrier has reached the threshold of that carrier; and
a number of consecutive DRX on all carriers counted by the UE variable numConsecutiveDTX has reached sl-maxNumConsecutiveDTX.

44. The method of claim 39, wherein determining there is a SL RLF in the SL carrier comprises:
maintaining a threshold for each SL carrier indicating one of a percentage or ratio of total number of consecutive DTX detected on all carriers; and
declaring a SL RLF for a PC5-connection responsive to:
for each SL carrier, the number of detected consecutive DTX on that carrier has reached the one of the percentage or ratio of the total number of consecutive DTX detected on all carriers; and
the number of consecutive DRX on all carriers counted by the UE variable numConsecutiveDTX has reached sl-maxNumConsecutiveDTX.

45. The method of claim 39, wherein reporting the SL RLF to the gNB, via an interface comprises sending signaling to the gNB informing the gNB of the occurrence of SL RLF on the SL carrier wherein the signaling contains at least one of:
when the SL RLF is declared for one or multiple SL carriers, including at least one of:
an identifier, ID, of the SL UE;
indices of the one or multiple SL carriers;
a first indicator indicating that SL RLF has been declared for the one or multiple carriers; and
at least an RLF cause when the RLF cause is known; and
when the SL RLF is declared for a PC5-RRC connection, including at least one of:
an identifier, ID, of the SL UE;
indices of all SL carriers associated with the PC5-RRC connection;
a second indicator indicating that SL RLF has been detected for the PC5-RRC connection; and
at least an RLF cause when the RLF cause is known.

46. The method of claim 45, wherein sending the signaling to the gNB comprises sending the signaling to the gNB via at least one of:
dedicated RRC signaling;
medium access control, MAC, control element, CE, based signaling;
a random access channel, RACH, procedure initiated at the SL UE;
a physical uplink control channel, PUCCH, transmission;
a configured grant-based transmission for carrying the signaling; and
a sounding reference signal, SRS, transmission.

47. The method of claim 39, further comprising:
receiving an indication from the gNB to perform at least one recovery action; and
performing the at least one recovery action responsive to receiving the indication.

48. The method of claim 47, wherein performing the at least one recovery action comprises performing at least one of:
deactivating the SL carrier responsive to the SL UE having established the PC5-RRC connection on the SL carrier;
de-configuring the SL carrier responsive to the SL UE having established the PC5-RRC connection on the SL carrier;
adding a SL carrier to replace the SL carrier on which the SL RLF has been detected;
informing the SL RLF to a peer SL UE via other SL carriers that remain active;
reconfiguring the SL carrier;
tearing down the PC5-RRC connection for the SL UE;
reconfiguring or reestablishing the PC5-RRC connection for the SL UE; and
de-activating CA for the PC5 connection between the two SL UEs.

49. The method of claim 48 wherein informing the SL RLF to the peer SL UE comprises signaling the peer SL UE of the SL RLF via at least one of:
PC5-S signaling;
PC5-RRC signaling;
MAC CE; and
L1 signaling on physical channels.

50. The method of claim 49 wherein signaling the peer SL UE comprises carrying at least one of:
identifiers of one or more SL carriers on which SL RLF have been detected;
an RLF cause for each of the one or more SL carriers; and
SL UE preferred actions for the one or more SL carriers on which SL RLF have been detected.

51. A method in a base station comprising:
receiving signaling from a sidelink, SL, user equipment, UE, configured with SL carrier aggregation, CA indicating detection of SL radio link failure, RLF, for a SL carrier;
sending a signaling to the SL UE informing the SL UE of at least one of:
deactivating the SL carrier on which the SL RLF has been detected for the SL UE;
de-configuring the SL carrier on which the SL RLF has been detected for the SL UE;
adding a SL carrier to replace the SL carrier on which the SL RLF has been detected;
informing the SL RLF to a peer SL UE of the SL UE via dedicated radio resource control, RRC, signaling;
reconfiguring the SL carrier;
tearing down the PC5-RRC connection for the SL UE;
reconfiguring or reestablishing the PC5-RRC connection for the SL UE; and
de-activating CA for the PC5 connection between the SL UE and the peer SL UE.

52. The method of claim 51, wherein sending the signaling comprises sending the signaling via at least one of:
system information;
dedicated RRC signaling;
medium access control, MAC, control element, CE; and
L1 signaling.

53. The method of claim 51, wherein sending the signaling comprises sending the signaling carrying at least one of:
identifiers of one or multiple SL carriers which need to be deactivated or de-configured; and
indicators of one or multiple SL carriers which need to be added.

54. A sidelink, SL, user equipment, UE, configured with SL carrier aggregation, CA, to handle SL radio link failure, RLF, per SL carrier, the SL UE adapted to:
monitor a hybrid automatic repeat request, HARQ, discontinuous transmission, DTX, per SL carrier;
for each SL carrier, determining that a HARQ-based SL RLF has occurred when a number of consecutive DT, numConsecutiveDTX, variable has reached a maximum number, sl-maxNumConsecutiveDTX, configured for the SL carrier; and responsive to determining there is a SL RLF in the SL carrier:
report SL RLF to at least one peer SL UE using at least one SL carrier of SL carriers that are not failed in a SL carrier configuration associated with the SL carrier having the SL RLF; and
report the SL RLF to a base station, gNB.

55. The SL UE of claim 54, wherein determining there is a SL RLF in the SL carrier comprises declaring that there is a SL RLF for a PC5 connection when at least one of:
a SL RLF on a carrier on which the PC5-connection is established has been declared;
a number of SL carriers on which SL RLF has been declared is above a configured number; and
a SL RLF is declared on all configured carriers.

56. The SL UE of claim 54, wherein determining there is the SL RLF in the SL carrier comprises determining there is the SL RLF in the SL carrier responsive to at least one condition being met;
wherein the at least one condition comprises at least one of:
a maximum number of out-of-sync on link instances has been reached;
a maximum number of RLC retransmissions has been reached;
a configuration error or a reconfiguration error occurs upon reception of a RRC configuration/reconfiguration signaling message;
a maximum number of consecutive HARQ DTX has been reached;
no expected acknowledgement received by the peer UE upon a timer has expired; and
an acknowledgement on an RLC transmission has not been received within a certain amount of time.

57. The SL UE of claim 54, wherein determining there is a SL RLF in the SL carrier comprises:
maintaining a common RRC maximum number parameter, sl-maxNumConsecutiveDTX, and a common UE variable, numConsecutiveDTX, for all configured SL carriers;
maintaining a threshold indicating number of consecutive DTX for each SL carrier;
declaring a SL RLF for a PC5-connection responsive to:
for each SL carrier, the number of consecutive DTX on that carrier has reached the threshold of that carrier; and
a number of consecutive DRX on all carriers counted by the UE variable numConsecutiveDTX has reached sl-maxNumConsecutiveDTX.

58. The SL UE of claim 54, wherein determining there is a SL RLF in the SL carrier comprises:
maintaining a threshold for each SL carrier indicating one of a percentage or ratio of total number of consecutive DTX detected on all carriers; and
declaring a SL RLF for a PC5-connection responsive to:
for each SL carrier, the number of detected consecutive DTX on that carrier has reached the one of the percentage or ratio of the total number of consecutive DTX detected on all carriers; and
the number of consecutive DRX on all carriers counted by the UE variable numConsecutiveDTX has reached sl-maxNumConsecutiveDTX.

59. The SL UE of claim 54, wherein reporting the SL RLF to the gNB, via an interface comprises sending signaling to the gNB informing the gNB of the occurrence of SL RLF on the SL carrier wherein the signaling contains at least one of:
when the SL RLF is declared for one or multiple SL carriers, including at least one of:
an identifier, ID, of the SL UE
indices of the one or multiple SL carriers;
a first indicator indicating that SL RLF has been declared for the one or multiple carriers; and
at least an RLF cause when the RLF cause is known; and
when the SL RLF is declared for a PC5-RRC connection, including at least one of:
an identifier, ID, of the SL UE
indices of all SL carriers associated with the PC5-RRC connection;
a second indicator indicating that SL RLF has been detected for the PC5-RRC connection; and
at least an RLF cause when the RLF cause is known.

60. The SL UE of claim 54, wherein the SL UE is further adapted to:
receive an indication from the gNB to perform at least one recovery action; and
perform the at least one recovery action responsive to receiving the indication;
wherein performing the at least one recovery action comprises performing at least one of:
deactivating the SL carrier responsive to the SL UE having established the PC5-RRC connection on the SL carrier;
de-configuring the SL carrier responsive to the SL UE having established the PC5-RRC connection on the SL carrier;
adding a SL carrier to replace the SL carrier on which the SL RLF has been detected;
informing the SL RLF to a peer SL UE via other SL carriers that remain active;
reconfiguring the SL carrier;
tearing down the PC5-RRC connection for the SL UE;
reconfiguring or reestablishing the PC5-RRC connection for the SL UE; and
de-activating CA for the PC5 connection between the two SL UEs.

61. A base station adapted to:
receive signaling from a sidelink, SL, user equipment, UE, configured with SL carrier aggregation, CA indicating detection of SL radio link failure, RLF, for a SL carrier;
send a signaling to the SL UE informing the SL UE of at least one of:
deactivate the SL carrier on which the SL RLF has been detected for the SL UE;
de-configure the SL carrier on which the SL RLF has been detected for the SL UE;
add a SL carrier to replace the SL carrier on which the SL RLF has been detected;
inform the SL RLF to a peer SL UE of the SL UE via dedicated radio resource control, RRC, signaling;
reconfigure the SL carrier;
tear down the PC5-RRC connection for the SL UE;
reconfigure or reestablish the PC5-RRC connection for the SL UE; and
de-activate CA for the PC5 connection between the SL UE and the peer SL UE.

62. The base station of claim 61, wherein sending the signaling comprises sending the signaling carrying at least one of:
identifiers of one or multiple SL carriers which need to be deactivated or de-configured; and
indicators of one or multiple SL carriers which need to be added.
